(19) United States
(12) Patent Application Publication
(10) Pub. No.: US 2025/0365372 A1
(43) Pub. Date: Nov. 27, 2025

(54) SECURE CALL ROUTING SYSTEM

(71) Applicant: Redyrect, LLC, Houston, TX (US)

(72) Inventors: Jonathan Blaisure, Clarence Center, NY (US); William Koehler, Houston, TX (US); Mark Schultz, Dallas, TX (US); Elliot Chocron, West Bloomfield, MI (US); Phil Colson, East Amherst, NY (US); Michael Colson, East Amherst, NY (US)

(21) Appl. No.: 18/674,219

(22) Filed: May 24, 2024

(51) Int. Cl. H04M 7/00; H04M 3/38

(52) U.S. Cl. CPC H04M 7/0033; H04M 3/38

(57) ABSTRACT

A call routing system and method comprising a branch exchange system designed to receive telephone calls. A session initiation protocol server is operative with the branch exchange system, the session initiation protocol server further having a firewall designed to allow telephone calls to pass therethrough. At least one automated attendant system is designed to request authentication for said telephone calls. At least one computerized telephone device is designed to receive telephone calls and notifications of telephone calls routed through the session initiation protocol server and sent from the branch exchange system. The branch exchange system is designed to route telephone calls based on the validity of the authentication and the presence or absence of a breakthrough number. A voicemail system may be included for message storage and converting audio files to text tiles, increasing, therefore, routing and message delivery options.

### FIELD OF THE INVENTION

The present invention generally relates to a call routing system designed to control accessibility to selected computerized telephone devices from callers.

### BACKGROUND

A problem that prominent or wealthy users often encounter, leading them to change their phone numbers frequently once their numbers become public, primarily revolves around privacy, security, and managing communication overload on their personal and business phones. Prominent or wealthy users, including celebrities, politicians, and high-profile individuals, have a heightened need for privacy due to the potential for harassment, unwanted communication, or even threats. When their phone numbers are leaked or shared publicly, they lose a significant level of control over who can contact them, exposing them to unwanted attention. Such can create a corollary problem in that other people in their network may not recognize a new number once a switch is made.

Publicly available phone numbers can make prominent or wealthy users vulnerable to various security risks, including hacking, phishing attempts, social engineering attacks, or simply an excessive number of calls from the public seeking to steal a moment of time with the prominent or wealthy user. Malicious individuals may attempt to exploit their personal information for financial gain, blackmail, or other nefarious purposes. Changing phone numbers regularly can help mitigate these risks by disrupting potential threats, but such changes can be disruptive with those people and institutions in the prominent or wealthy user's permitted network.

Prominent or wealthy users often receive a large volume of calls, texts, and messages from fans, supporters, constituents, and even adversaries when their numbers are publicized. Managing this influx of communication can be overwhelming and time-consuming, detracting from their ability to focus on their professional duties or personal lives. Changing phone numbers can provide temporary relief from this communication overload, but such is likely to be temporary until the new number itself gets out to the public.

By changing their phone numbers frequently, prominent or wealthy users regain a sense of control over their communication channels. It allows them to limit access to their personal contact information, ensuring that only trusted individuals and essential contacts have access to their current phone number. Despite efforts to maintain confidentiality, prominent or wealthy users' phone numbers may inadvertently leak through various channels, including social media, press releases, or data breaches. Regularly changing phone numbers can help mitigate the impact of these leaks and prevent long-term exposure of their personal contact information.

The need for privacy, security, and managing communication overload drives prominent or wealthy users to change their phone numbers frequently once their numbers become public. This practice helps them maintain control over their communication channels, protect against security risks, and mitigate the consequences of leaks or unwanted attention. But there is a strong need in the market for an improved solution whereby even if their phone numbers become available to the public, prominent or wealthy users can confidently still control who can access them without requiring them to change their phone numbers.

### SUMMARY OF THE INVENTION

Disclosed is a call routing system and method that has a branch exchange system designed to receive telephone calls. A session initiation protocol server is operative with the branch exchange system, the session initiation protocol server further having a firewall designed to allow telephone calls to pass therethrough. At least one automated attendant system is designed to request authentication for the telephone calls. At least one computerized telephone device is designed to receive telephone calls and notifications of telephone calls routed through the session initiation protocol server and sent from the branch exchange system. The branch exchange system is designed to route telephone calls based on the validity of the authentication.

In some embodiments of the call routing system, the telephone calls are further validated by way of automatic number identification. In some embodiments of the call routing system, telephone calls are designed to be routed based on validation of at least one breakthrough routing identifier. Some embodiments of the call routing system include at least one second breakthrough routing identifier. In some embodiments of the call routing system, the branch exchange system is designed to allow users to add, change, and remove people from whom telephone calls with valid authentication will be accepted.

In some embodiments of the call routing system the branch exchange system is designed to validate selected authentication only if entered within selected time periods assigned to those selected authentications. In some embodiments of the call routing system, breakthrough routing identifiers are designed to override invalidations of the selected authentications.

In some embodiments of the call routing system, the branch exchange system is designed to block selected authentications if entered outside selected time periods assigned to those given authentications. In some embodiments of the call routing system, breakthrough routing identifiers are designed to override authentication blocks.

In some embodiments of the call routing system, the branch exchange system is designed to validate selected telephone calls within selected time periods assigned to those selected telephone calls. In some embodiments of the call routing system, breakthrough routing identifiers are designed to override invalidations of the selected telephone calls.

Some embodiments of the call routing system include a voicemail system operative with the branch exchange system and the at least one computerized telephone device, the voicemail system designed to record the telephone calls as audio files. These embodiments include a speech-to-text software program designed to convert the audio files into text files. These embodiments include at least one database operative with the voicemail system designed to receive and store audio files and text files of the recorded telephone calls. These embodiments include the branch exchange system designed to deliver audio files and text files from the at least one database to corresponding computerized telephone devices of the at least one computerized telephone device.

In some embodiments of the call routing system, telephone calls are routed to the voicemail system upon receipt by the branch exchange system of corresponding identity codes. In some embodiments of the call routing system, the branch exchange system is designed to deliver audio files and text files to at least one computerized telephone device. In some embodiments of the call routing system, the branch exchange system is designed to deliver audio files and text files to at least one computerized telephone device by way of manual direction.

In some embodiments of the call routing system, each computerized telephone device of the at least one computerized telephone device can be configured to one of multiple audio file and text file delivery options. In some embodiments of the call routing system, each computerized telephone device of the at least one computerized telephone device can be configured wherein audio file and text file delivery options include assigning at least one priority-level identifier for a period of time to the corresponding audio files and text files. In some embodiments of the call routing system, the at least one priority-level identifier is assigned manually. In some embodiments of the call routing system, a large language module is designed to analyze audio files and text files for at least one or more of terms, context, inflection, and speech pattern similarity.

These and other objects, features, and advantages of the present invention will become readily apparent upon a review of the following detailed description of the invention, in view of the drawings and appended claims.

### BRIEF DESCRIPTION OF THE DRAWINGS

The nature and mode of the operation of the present invention will now be more fully described in the following detailed description of the invention taken with the accompanying drawing figures, in which:

FIG. 1 illustrates a representative call routing system with branch exchange system and voicemail system;

FIG. 2 illustrates a representative session initiation protocol server system of the branch exchange system;

FIG. 3 illustrates representative authentication and breakthrough flow;

FIG. 4 illustrates toggle switches on a user interface of a representative computerized telephone device;

FIG. 5 illustrates message routing to multiple representative computerized telephone devices from the representative voicemail system; and,

FIG. 6A-6E illustrates a representative call routing method.

### DETAILED DESCRIPTION OF THE INVENTION

Following are detailed descriptions of various concepts related to, and embodiments of, methods and apparatus according to the present invention. It should, however, be understood that this disclosure is not limited to the particular methodology, materials, and modifications described and, as such, may, of course, vary. It is also understood that the terminology used herein is for the purpose of describing particular aspects only and is not intended to limit the scope of the claims.

Furthermore, it should be appreciated that drawings are representative to illustrate the inventive concepts herein and may not be to scale. Also, like drawing numbers on different drawing views identify identical, or functionally similar, structural elements where there could appear some variations on exactness where exactness is not material to the inventive concept herein. It is to be understood that the claims are not limited to the disclosed aspects.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

The invention is a call routing system, wherein a call routing system is a telecommunications infrastructure that efficiently directs incoming calls to the most appropriate destination within an organization or network and includes a branch exchange system and may further have variations termed a PBX (Private Branch Exchange) or IP-PBX system. Branch exchange systems use predefined rules and algorithms to determine where each incoming call should be forwarded based on various criteria such as the caller's input, the time of day, the availability of agents or departments, and the nature of the call. Call routing systems, at the basic level, ensure that callers are connected to the right parties and may further optimize communication workflows through such additions as automatic call distribution. Branch exchange systems may further incorporate features such as interactive voice response (IVR) menus, skill-based routing, priority routing, and integration with customer relationship management (CRM) systems to enhance efficiency and responsiveness in handling incoming calls.

The disclosed invention, however, advances the concept of a call routing system as a solution to improve how high-profile people, often termed prominent or wealthy users, VIPs, or Very Important Persons can, while engaged with public networks, can receive calls from people within a selected inner circle of contacts without needing to change telephone numbers frequently as those telephone numbers leak to the public. The invention provides at least one other layer wherein undesired calls, or calls that may be unwanted at given times or under given circumstances, will be invalidated, blocked, or otherwise routed elsewhere in the system or out of the system. The invention offers, therefore, an improvement in how call routing systems can operate.

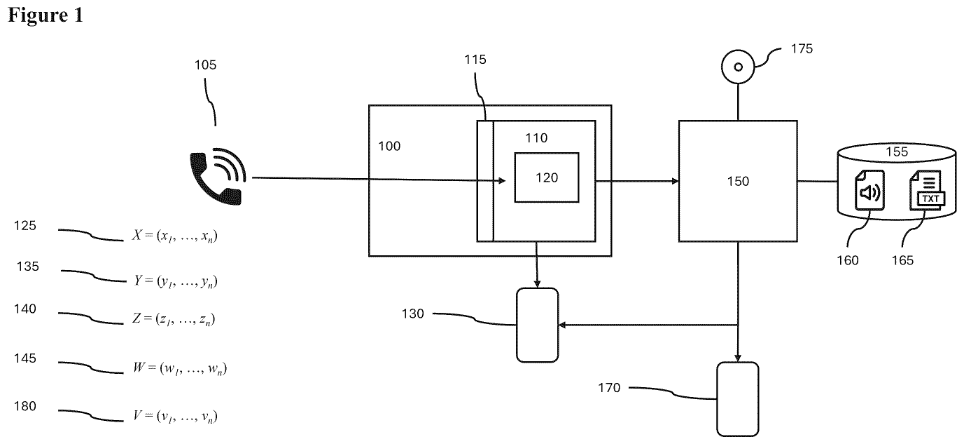

Adverting now to FIG. 1, illustrated is representative call routing system 10 that includes representative branch exchange system 100 designed to receive telephone calls 105. Branch exchange system 100 allows internal communication between different telephone extensions within the organization without using public telephone networks, allows incoming and outgoing calls to and from public telephone networks, and automatically routes calls to appropriate extensions based on dialed numbers, depending on authentications 125, a description of which will follow.

Branch exchange system 100, in the representative embodiment, is a hardware-based system but may also be a software-based system, often referred to as IP PBX when using internet protocols (IP) for communication, though naturally hardware-based elements supporting branch exchange system 100 have a physical presence somewhere. Hardware for the branch exchange system 100, namely telephone switches, software emulations thereof, and associated components, may be locally or remotely based, the more important aspect being that there is operative connectivity by way of branch exchange system 100 to callers, call recipients, and features of branch exchange system 100 necessary for the disclosed call routing system 10 to function.

Further illustrated in FIG. 1 is one such feature, a session initiation protocol server 110 operative with branch exchange system 100, session initiation protocol server 110 further having a firewall 115, this being a network security device or software that monitors and controls incoming and outgoing network traffic based on predetermined security rules, designed to allow selected telephone calls 105 to pass therethrough, but which may further be designed to block other telephone calls 105 early upon their receipt by way of information such as, but not limited to, automatic number identification 135. Session initiation protocol server 110, as designed for branch exchange system 100, integrates with traditional branch exchange functionality wherein session initiation protocol server 110 is designed to handle voice-based and text-based messaging as in a VoIP environment.

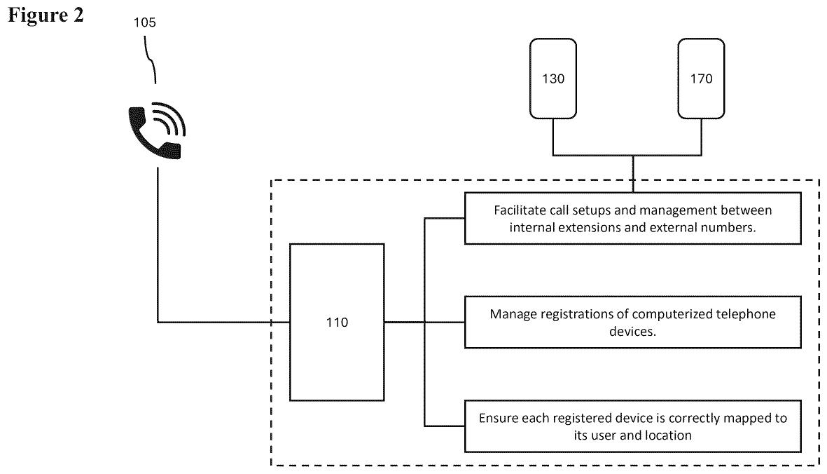

As illustrated in FIG. 2, important roles of the session initiation protocol server 110 include: 1) facilitating call setups and management between internal extensions and external numbers, 2) managing registrations of at least computerized telephone devices 130 and second computerized telephone devices 170 and 3) ensuring that each such registered device is correctly mapped to its user and location within branch exchange system 100 network. Further managed by session initiation protocol server 110 is the presence of users, indicating their availability for communication, availability of expected telephony features such as call forwarding, call transfer, voicemail, conferencing, auto-attendant services, and availability of features unique to the invention to be discussed. Session initiation protocol server 110 is designed to ensure secure communication through user authentication 125, encryption of signaling and media, and prevention of unauthorized access, including approaches specific to the disclosed invention. FIG. 1 illustrates a representative authentication 125 as it could appear as a numerical pin number of some length n, but letters and symbols can be used along with other types of input code which will follow where the operative criterion is that parties being authenticated either can or cannot successfully input a requested code termed here as authentication 125.

Further illustrated in FIG. 1 is at least one automated attendant system 120 designed to request authentication 125 for telephone calls 105. Automated attendant system 120 is designed to automatically answer incoming calls and provide a menu of options for callers. The automated attendant system 120, in embodiments of the invention, directs callers to the appropriate extension or to information without needing a human operator and includes, but is not limited to, routing calls to extensions or voicemail boxes and providing pre-recorded greetings and instructions, menu options, directory assistances, voicemail integration, and can be programmed to provide different messages and routing options based on the time of day, day of the week, and specific days such as holidays. Automated attendant system 120 further enables call routing system 10 by providing prompts specific to the invention, which will follow. The concept of automated attendant system 120 may also be known or referred to as, but not limited to, auto attendant, virtual receptionist, voice response unit, interactive voice response, voice menu system, digital assistant, phone mail, and automatic call distribution. An extension may be separate numbers from phone numbers of computerized telephone devices 130 or second computerized telephone devices 170 and may also comprise phone numbers of computerized telephone devices 130 or second computerized telephone devices 170.

Further illustrated in FIG. 1 is at least one computerized telephone device 130 designed to receive telephone calls 105 and notifications of telephone calls 105 routed through session initiation protocol server 110 and sent from branch exchange system 100. Computerized telephone device 130 is from a set of at least one computerized telephone device 130 designed or otherwise registered to be a part of a system of computerized telephone devices 130 managed by branch exchange system 100 that combines the features of traditional telephony with computer systems to enhance communication capabilities and streamline various telephony functions. Arrangements of at least one computerized telephone device 130 can be parsed according to the creation of sets in traditional set theory wherein if computerized telephone device 130 would be given the variable d, then at least one computerized telephone device 130 could also be described as {d₁, . . . dₙ} where n is an integer greater than or equal to 1.

Computerized telephone device 130, as typical of such devices, leverages computer technology to manage, route, and control telephone calls 105, and is designed to integrate with other computer applications to provide a unified communication experience and, therefore, includes such expectable features as: 1) call forwarding, call transfer, call hold, and call conferencing; 2) implementing voice responses of automated attendant system 120 designed to allow callers to interact via voice or keypad inputs to get information or route their calls to the appropriate extensions or parties; 3) interacting with voicemail systems 150; 4) providing real-time information about callers, such as caller ID, account information, and previous interactions, displayed on the user's computer screen when a call is received; 4) providing reporting and analytics on call metrics, such as call volume, call duration, and response times, which can be used for performance analysis and decision-making; 5) supporting remote access to telephony features of branch exchange system 100 through mobile apps or web interfaces; and 6) incorporating security features such as encryption, authentication 125, and call logging to protect sensitive communication. Examples of computerized telephone devices 130 as may be used in the disclosed invention include but are not limited to: 1) Smartphones such, but not limited to, an iPhone® and Android® phones, which may further be termed handheld mobile devices; 2) IP phones that connect to the internet and provide advanced features through software integration, such as Cisco IP Phones and Polycom VVX Series; 3) Softphones applications that run on computers or mobile devices to make and receive calls over the internet, such as Skype, Zoom, and Bria; call center software that manages incoming and outgoing calls, integrate with CRM systems, and provide tools for managing call center operations, such as Five9 and Genesys; and 4) Unified communications systems that integrate voice, video, messaging, and collaboration tools into a single system, such as Microsoft Teams and Cisco WebEx. From these representative examples, therefore, computerized telephone device 130 is expected to be a communication device with the computer-based, digital feature designed to interact with the disclosed call routing system 10, both its conventional features and those specific to or as specifically configured for the disclosed invention.

Branch exchange system 100 is designed to route telephone calls 105 based on the validity of authentication 125. In one representative embodiment, authentication 125 is achieved by way of a pin number, the pin number most typically keyed in, or read in by speaking the integers, by way of smartphones or other telephone devices used by parties seeking to be authenticated. Authentication 125, however, is defined by any system where encoded information is entered by the party being authenticated wherein encoded means information is presented in a digital format or converted to a digital format wherein—to an acceptable threshold of error ranging from no error, such as the pin number, to some accepted range or variance from an expected value, such as voice print analysis—the party being authenticated is verified, not verified, or deemed to require at least one more verification attempt. Foundational calculations would include, but are not limited to,

$${σ}^{2} ( {x}_{i} ) = \frac{1}{N} {\sum }_{j = 1}^{N} {( {x}_{i j} - {μ}_{i} )}^{2}$$

where σ²(xᵢ) is the variance of an i-th feature, N is a total number of voice samples, xᵢⱼ is a value of the i-th feature for a j-th voice sample, and μᵢ is the mean of the i-th feature across all voice samples given by

$${μ}_{i} = \frac{1}{N} {\sum }_{j = 1}^{N} {x}_{ij} ,$$

the example representing variance as a measure of the spread or variability in the feature set extracted from voice signals as used, for example, in computing the variance of voice feature vectors, such as Mel-Frequency Cepstral Coefficients (MFCCs), over a set of voice samples. Other related equations may be used where common variables include the number of samples, the variance, and the mean where methods and measures are used to parse members of a sample set for authentication 125 codes, such as voice, that may have variability. For example, similar equations may be used for authentication 125 based on such factors as word choice, frequency, and patterns such as, for illustration, to match voice tone with previous samples of word choice when authenticating whether a party both has the right voice tone and is using language close enough to a known pattern of language that it is likely to be from the party being authenticated.

Other authentication 125 embodiments include, but are not limited to: 1) automatic number identification 135 (ANI), which uses the caller's phone number for validation; 2) caller ID callback, wherein the system disconnects the call and calls the number back; 3) voice recognition, wherein the system analyzes the caller's voice and compares it with a pre-recorded voiceprint to verify identity; 4) speech patterns, wherein unique speech patterns, intonation, and other vocal characteristics are analyzed; 5) security questions, wherein the caller answers pre-set security questions (e.g., mother's maiden name, first pet's name) to confirm their identity, personal information, wherein the caller is validated by asking for specific personal information, such as date of birth, address, or account number; 5) two-factor authentication (2FA) such as SMS or email code wherein parties are sent a one-time passcode (OTP) to the caller's registered mobile number or email, which the caller must enter to validate the call; 6) authenticator apps where an app such as Google Authenticator is used to generate a time-based OTP for call validation; 7) registered devices, wherein a call is validated if the call comes from a pre-registered device, such as a specific mobile phone or computer; SIM card verification which confirms the caller's identity by checking the SIM card information against records; 8) GPS location which verifies the caller's location through GPS data from their mobile device; 9) IP address which checks the caller's IP address to ensure it matches the expected geographical region; 10) DTMF tones wherein the caller is prompted to press specific keys on their phone, which generate dual-tone multi-frequency signals for validation; 11) voice commands which use specific spoken commands that the IVR system recognizes for validation; 12) physical tokens or cards, smart cards wherein the caller inserts a smart card into a reader connected to their phone or computer; 13) hardware tokens which use a physical token that generates a time-based OTP for validation; 14) face recognition wherein facial recognition software is used to authenticate the caller; 15) secure certificates that use digital certificates installed on the caller's device to validate the identity of the caller through cryptographic methods; 16) blockchain certification wherein authentication occurs by way of a public ledger; 17) retinal authentication wherein unique eye patterns are used to provide authentication, and 18) fingerprint authentication wherein fingerprints are used to provide authentication. Combinations of such approaches for authentication 125 may be used. For example, fingerprint authentication may still require a pin number, or may require such other authentication as requested. As such, the invention is designed to be configurable to have potentially many layers of authentication that parties must navigate in environments where such layers are prudent for parties receiving calls.

In some embodiments of the call routing system 10, telephone calls 105 are further validated by way of automatic number identification 135, and such may, in some embodiments, be the first layer of authentication 125 to screen parties that may more readily be identified as desired or undesired or wherein the party to a given number will be matched or synchronized with authentications 125 by way of the validation approaches exemplified by embodiments (1) through (18) listed above.

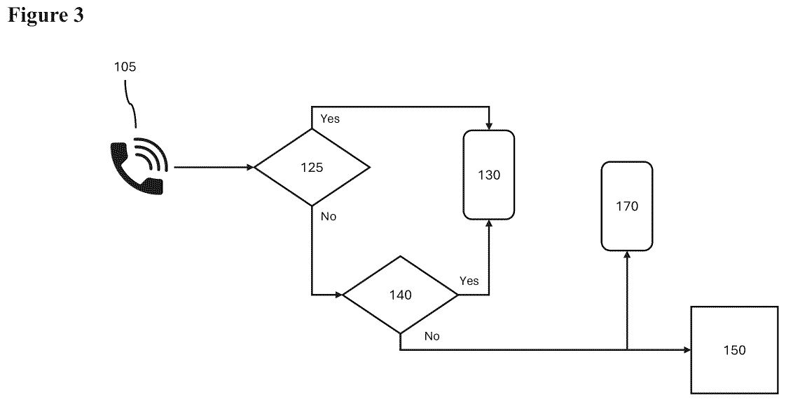

FIG. 3 illustrates that, in some embodiments of the call routing system 10, telephone calls 105 are designed to be routed based on validation of at least one breakthrough routing identifier 140. As illustrated, if a call that has passed through firewall 115 of session initiation protocol server 110 is not validated to directly reach computerized telephone device 130, breakthrough routing identifier 140 may override the invalidation before redirecting the call to such routing, as representatively illustrated, to voicemail 150 or to at least one second computerized telephone device 170 or a supporting device such as another computerized non-telephonic device. Breakthrough routing identifiers 140 are code, such as an ordered set of integers, used to direct a telephone call 105 through the network to its intended destination. Breakthrough routing identifier 140 is coded information designed to override verification invalidation or override a previous routing decision from branch exchange system 100 or call recipient and may be or include breakthrough validation approaches apart from authentication 125 such as a pin, password, or other such identifier that while apart from authentication 125, may include validation approaches one through eighteen listed in previous paragraphs above. Other breakthrough routing identifiers 140 include, but are not limited to: 1) direct inward dialing numbers assigned to an organization that allow external callers to reach an internal extension directly without going through a main switchboard; 2) extension or private extension numbers assigned to individual phones within an organization, allowing for direct internal calls and routing from main lines; 3) direct number identification services, branch exchange system 100 codes designed to route calls to various extensions, departments, or external numbers; 4) automatic call distribution codes; 5) virtual phone numbers not tied to a specific phone line but that can be programmed to forward calls to various destinations such as mobile phones, landlines, or VoIP systems; and 6) interactive voice response menus that prompt callers to enter specific inputs (e.g., “Press 1 for Emergency”) to route the call to an appropriate department or extension despite the call being otherwise blocked, invalidated, or rerouted. Short numbers (often 5-6 digits) may be used which may be temporary or permanent, and in such instances, other validation may be entered or have already been entered, such as a pin number.

Breakthrough routing identifier 140 may be a singular signal such as the above “Press 1 for Emergency.” Alternatively, breakthrough routing identifier 140 may itself be a code of some length and complexity, balancing, therefore, ease of use, expedience of use, and providing a code that would be hard to substantially impossible to guess within a relevant timeframe and use case. Breakthrough routing identifier 140, therefore, is designed to give agency to callers possessing their respective breakthrough routing identifiers 140 to reach recipients and, therefore, resolves an important contradiction resolved by the invention: to on one hand have a telecommunications system secure enough to keep unwanted calls away from recipients, this without recipients needing to change those telephone numbers, while at the same time allowing callers possessing breakthrough routing identifiers 140—which are typically less likely to be leaked to the public than a telephone number and easier to change without changing the associated telephone number—a way to reliably reach recipients under circumstances where recipients would, in fact, wish to receive their calls.

The invention may include session initiation protocol system identifiers which may be used in VoIP systems to route calls to specific endpoints associated with the branch exchange system 100, similar to email addresses for telephony, and may further route calls by way of uniform source identifiers to specific addresses, such as user@domain.com, similar to web URLs but for phone calls. Some embodiments of the call routing system 10, may have at least one second breakthrough routing identifier 145, allowing, therefore, differing priority levels for breakthroughs or another breakthrough layer to pass before reaching recipients.

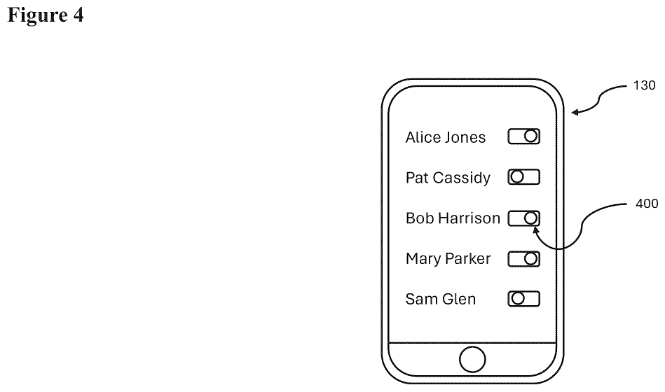

FIG. 4 illustrates that, in some embodiments of the call routing system 10, branch exchange system 100 is designed to allow users to add, change, and remove people from whom telephone calls 105 with valid authentication 125 will be accepted. For illustration, once a party is added to branch exchange system 100, toggle switch 400 of computerized telephone device 130 may be activated to allow parties to reach a given recipient by way of breakthrough routing identifier 140. For illustration, a business development executive who might not normally have access to call a company president directly might be added so she can reach that company president during an important negotiation and might, therefore, later be toggled as active on the day of the negotiation, and then later be removed as a party for which a breakthrough routing identifier 140 would be allowed.

In some embodiments of the call routing system 10, branch exchange system 100 is designed to validate selected authentication 125 only if entered within selected time periods assigned to those selected authentications 125. Selected time periods generally refer to specific durations or intervals of time that have been chosen or designated for a particular purpose. Selected time periods could refer to designated hours during which certain operations or services happen such as work hours. Selected time periods may denote periods of availability or non-availability, sometimes termed a schedule and scheduling, for example, indicating when someone is available for meetings or appointments during selected time periods throughout a given day. Selected time periods may be any length of interval between the start and the end of a given time period as could be measured in time units such as seconds, minutes, hours, days, weeks, months, years, and fractions or combinations thereof. In some embodiments of call routing system 10, breakthrough routing identifiers 140 are designed to override authentication 125 invalidations or may selectively, such as by time period, override authentication 125 invalidations.

In some embodiments of call routing system 10, branch exchange system 100 is designed to block selected authentications 125 if entered outside selected time periods assigned to those given authentications 125. In some embodiments of the call routing system 10, breakthrough routing identifiers 140 are designed to override authentication 125 blocks.

In some embodiments of call routing system 10, branch exchange system 100 is designed to validate selected telephone calls 105 within selected time periods assigned to those selected telephone calls 105. In some embodiments of the call routing system 10, breakthrough routing identifiers 140 are designed to override invalidations of the selected telephone calls 105.

The disclosed branch exchange system 100, in some embodiments, is designed to be able to use digital voicemail systems 150 as a call routing pathway of the disclosed call routing system 10. Digital voicemail system 150 features a messaging system designed to record, store, and manage voice messages using digital technology. Voicemail system 150 features remote access, integration with email, and other messaging services, along with the ability to store ample volumes of messages by way of either or both local and remote databases 155. Voicemail system 150, in some embodiments, is a part of branch exchange system 100 and in other embodiments may be hosted by telecom service providers, but in either case allows users to access messages from devices with internet connectivity.

Voicemail system 150 is an electronic system that records and stores voice messages from callers when recipients are unavailable. Some embodiments of the call routing system 10 include voicemail system 150 operative with branch exchange system 100 and at least one computerized telephone device 130. Voicemail system 150 is designed to record telephone calls 105 as audio files 160. The disclosed invention uses voicemail system 150 further as a tool for parties receiving calls to manage who can reach parties directly by providing an alternate route where messages may be received and to allow not just access to voice mailboxes from others, such as an executive assistant, but having voicemails sent to multiple mailboxes such as a representative executive and representative executive assistant wherein recipients can retrieve, listen to, and manage messages at their convenience.

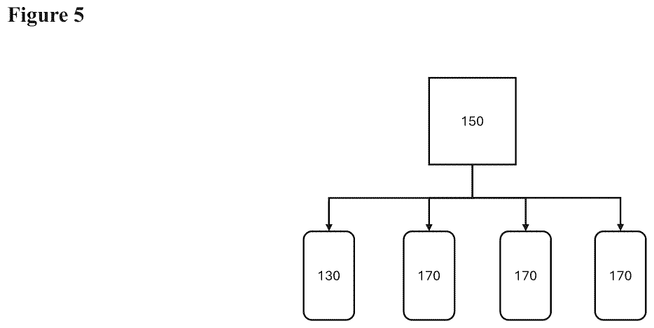

Illustrated in FIG. 5 is voicemail system 150 which, in this representation, is configured to deliver messages to computerized telephone device 130 and three second computerized telephone devices 170. Voicemail system 150 in the disclosed invention may further be integrated with VoIP phone systems. Voicemail system 150 provides a call routing path of the call routing system 10 where calls may be routed.

Embodiments including a voicemail system 150 include a speech-to-text software program 175, illustrated in FIG. 1, designed to convert the audio files 160 into text files 165, also illustrated in FIG. 1. These embodiments include at least one database 155 operative with the voicemail system 150 designed to receive and store audio files 160 and text files 165 of the recorded telephone calls 105. These embodiments include branch exchange system 100 being further designed to deliver audio files 160 and text files 165 from the at least one database 155 to corresponding computerized telephone devices 130 of at least one computerized telephone device 130 and, potentially, multiple computerized telephone devices 130.

Speech-to-text transcription, as used in the invention, converts spoken language into written text. Speech-to-text processing is designed to involve recording spoken words through a microphone or other audio input device, which the software then analyzes and transcribes into text. The core component of speech-to-text software is speech recognition, which involves algorithms that process and convert audio signals into text. Forms of speech-to-text processing may use machine learning and natural language processing (NLP) to improve accuracy by learning from context and user-specific language patterns. For example, speech-to-text software will typically use N-gram models to estimate the probability of a sequence of words by assuming that each word depends on the previous (n−1) words to some set degree n. The invention may further use such data to develop other probability models that add context to given message once transcribed, for example, comparing to or training on known data where certain emergencies may be occurring that should create or prioritize a breakthrough as could be achieved with such approaches as similarity (w₁,w₂)=w₁·w₂/∥w₁∥∥w₂∥, where the cosine similarity between word vectors indicates semantic similarity. These approaches help in capturing contextual meaning and relationships between words in transcribed text.

Speech-to-text software program 175 is designed to perform in real-time or near-real-time without human intervention, and such mathematical models as may be used to analyze the resulting text are designed for accuracy and contextual understanding and may be used in tandem with analyses of the original voice source to detect patterns such as a tone of voice likely to indicate a message of greater or lesser importance than other messages from given callers, further distinguish speakers as individuals, attribute text to the correct individuals, and flag anomalies that may represent faked messages. Mathematical models which may be used are numerous when assessing the authenticity of messages, but fundamentally are designed to compare expected patterns of either or both sound and text with observed corresponding patterns and the accepted variance thereof per E[X]=∫_{-∞}^{∞}xf(x) dx or its discrete counterpart.

For illustration, the invention uses Bayesian models, a probabilistic framework that updates the probability of a hypothesis or expectation E based on new evidence. Bayes' Theorem mathematically expresses the relationship between the prior probability (initial expectation), the likelihood (the probability of observing the data given the hypothesis), and the posterior probability (updated expectation after considering the new evidence). Further, conditions are considered where, for example, X may be conditional on Y (X|Y), where if Y=y, than there is a probability that X=x where x could, for example, be a possible word x of a set of possible words, X, likely to follow known word y with a probability from greater than zero to less than or equal to one. Included may be equations and libraries from such approaches as: Unsupervised Learning, Linear Regression, Classification-Neural Networks to create array of voice print, Emotional Recognition/Sentiment Recognition, Feature Extraction, Tokenization, Stemming, and Domain classification (such as emergent connotation), where the systems and goals are to manage entropy from the creation of code—such as recorded voice information—to the receipt and interpretation of the created code—such as the creation of text from the recorded voice information where the end-to-end transmission and use of code is accurate enough to produce the desired validation and accuracy outcomes.

Speech-to-text transcription program 175, therefore, is designed to use probability theory and associated mathematical theories to enhance the accuracy of converting spoken language into written text by employing statistical models from which to gain context, assess logical and emotional message component, identify likely meaning, and foster understanding, which in turn informs how calls are routed. Language models, such as N-grams and Hidden Markov Models (HMM), may be used to calculate the probability of word sequences and phoneme transitions based on observed data. Acoustic models, including Gaussian Mixture Models (GMM) and Deep Neural Networks (DNN), may be used to estimate the likelihood of specific acoustic features corresponding to phonemes or words. Viterbi algorithm and beam search techniques may be used in decoding to find the most probable sequence of words, while contextual models such as Conditional Random Fields (CRF) and Transformer models may capture dependencies and context within assessed speech. By integrating these probabilistic approaches, the invention is designed to accurately predict and transcribe spoken language on demand to the level useful for the given operations of the invention, ranging from transcribing with no further analysis to transcribing with individual language pattern comparisons as might be useful to prevent fake messages often termed in industry as deep fakes. The results of these analyses may be incorporated into breakthrough routing identifiers 140 as an element from which call recipients choose or have chosen those calls allowed to break through at given times and under given circumstances to at least one computerized telephone device 130.

In some embodiments of the call routing system 10, telephone calls 105 are routed to the voicemail system 150 upon receipt by the branch exchange system 100 of corresponding identity codes such as automatic number identification. In some embodiments of the call routing system 10, branch exchange system 100 is designed to deliver audio files 160 and text files 165 to at least one computerized communication device such as, but not limited to, the representative computerized telephone device 130. In some embodiments of the call routing system 10, branch exchange system 100 is designed to deliver audio files 160 and text files 165 to at least one computerized communication device 130 by way of manual direction.

In some embodiments of the call routing system 10, each computerized telephone device 130 of the at least one computerized telephone device 130 can be configured to one of multiple audio file 160 and text file 165 delivery options and file formats. In some embodiments of the call routing system 10, each computerized telephone device 130 of the at least one computerized telephone device 130 can be configured wherein audio file 160 and text file 165 delivery options include assigning at least one priority-level identifier 180 for a selected time period to the corresponding audio files 160 and text files 165. In some embodiments of call routing system 10, the at least one priority-level identifier 180 is assigned manually. In some embodiments of the call routing system 10, a large language module is designed to analyze audio files 160 and text files 165 for at least one or more of terms, context, inflection, and speech pattern similarity. A large language model is an artificial intelligence model designed to understand, generate, and interact with human language in a meaningful way inclusive of aforementioned algorithms where variables may be vector variables and may be random variables and where calculations for similarities and meanings may be statistical and probabilistic.

It should be understood that FIG. 1 presents representative authentication 125, automatic number identification 135, breakthrough routing identifier 140, second breakthrough routing number 145, and priority level identifier 180, as numerical sequences but that aforementioned code presented throughout this specification, such as letters, symbols, and such discernable information such as voiceprints, fingerprints, and other biometrics, may be used as available and appropriate to given use cases. The representative examples are not intended to be limiting, just representative.

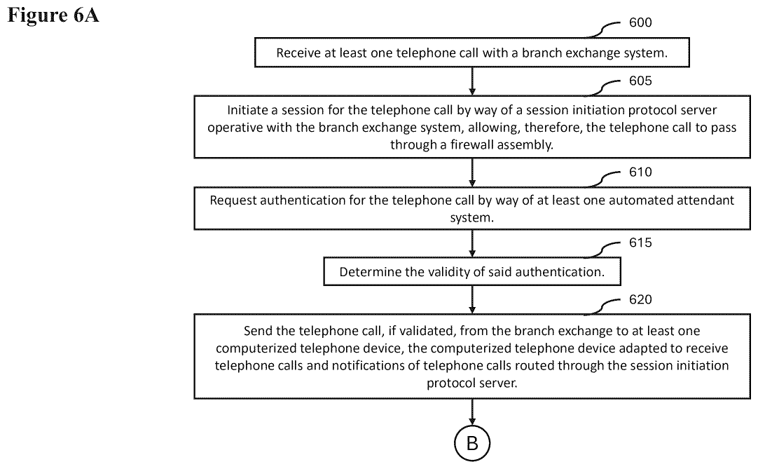

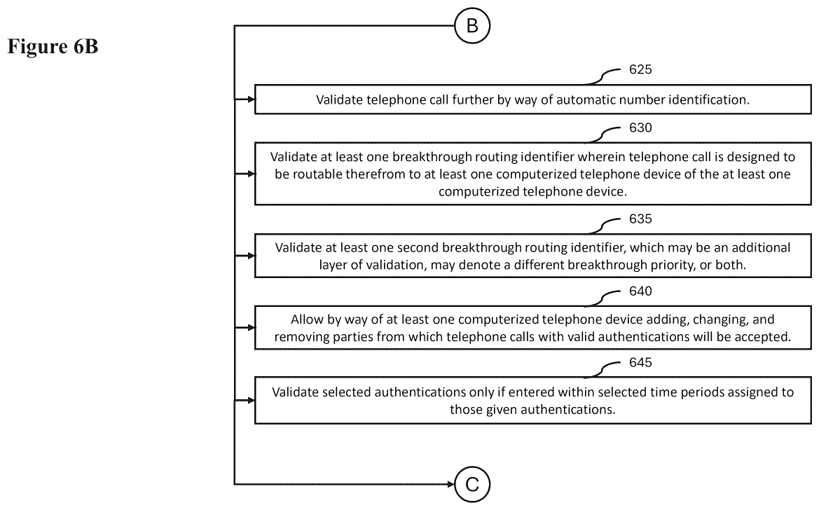

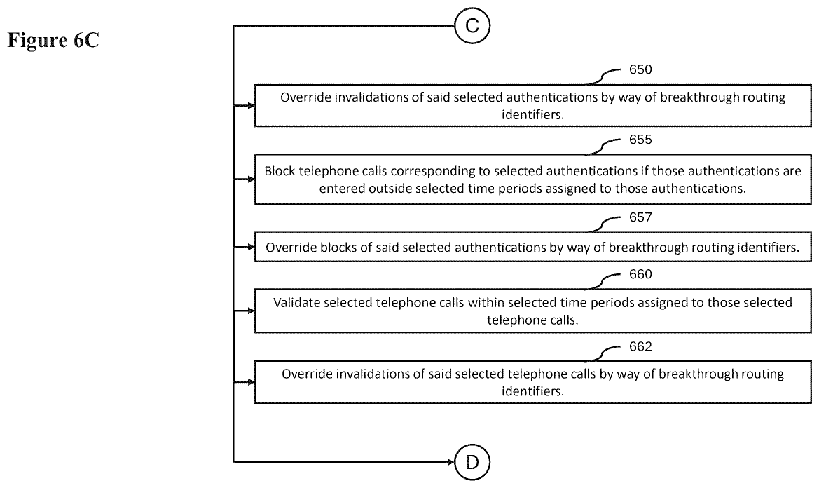

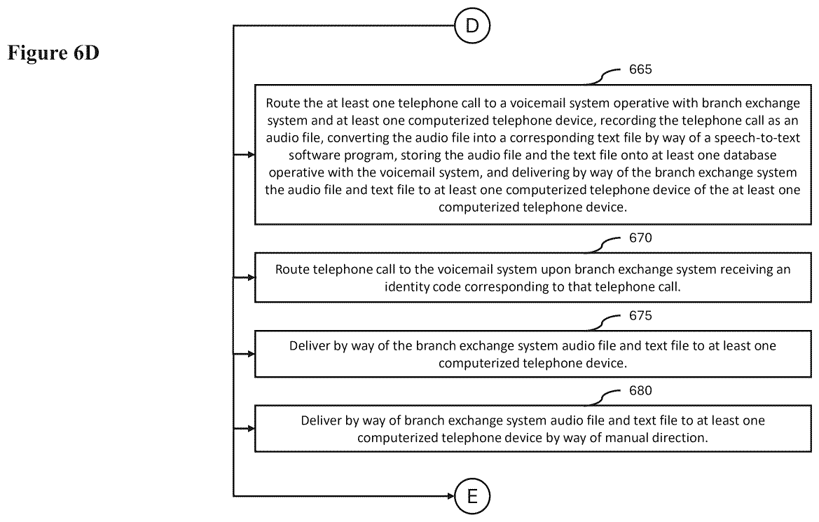

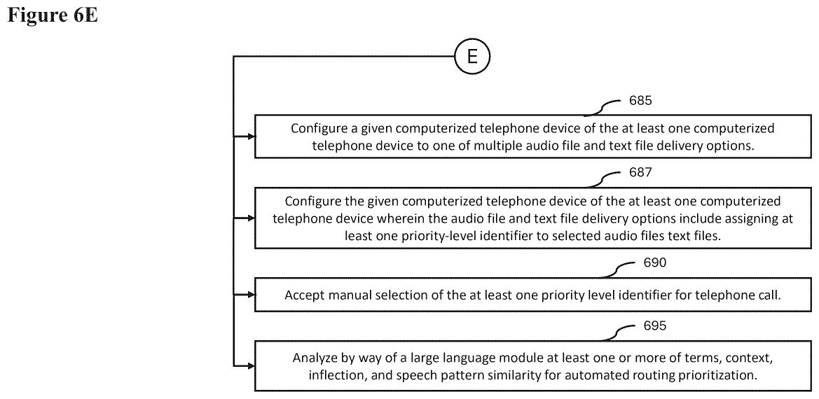

FIGS. 6A-6E illustrate a representative call routing method of call routing system 10 that includes the step of 600, receiving at least one telephone call 105 with a branch exchange system 100. The call routing method includes the step of 605, initiating a session for the telephone call 105 by way of a session initiation protocol server 110 operative with the branch exchange system 100, allowing, therefore, telephone call 105 to pass through firewall 115. The call routing method includes the step of 610, requesting authentication 125 for telephone call 105 by way of at least one automated attendant system 120. The call routing method includes the step of 615, determining the validity of the authentication 125. The call routing method includes the step of 620, sending telephone call 105, if validated, from branch exchange system 100 to at least one computerized telephone device 130, computerized telephone device 130 designed to receive telephone calls 105 and notifications of telephone calls 105 routed through session initiation protocol server 110.

The call routing method may include the step of 625, validating telephone call 105 further by way of automatic number identification 135. The call routing method may include the step of 630, validating at least one breakthrough routing identifier 140 wherein telephone call 105 is designed to be routable therefrom to at least one computerized telephone device 130 of the at least one computerized telephone device 130. The call routing method may include the step of 635, validating at least one second breakthrough routing identifier 145, which may be an additional layer of validation, may denote a different breakthrough priority, or both.

The call routing method may include the step of 640, allowing by way of at least one computerized telephone device 130 adding, changing, and removing parties from which telephone calls 105 with valid authentications 125 will be accepted.

The call routing method may include the step of 645, validating selected authentications 125 only if entered within selected time periods assigned to those given authentications 125. The call routing method may include the step of 650, overriding invalidations of the selected authentications 125 by way of breakthrough routing identifiers 140.

The call routing method may include the step of 655, blocking telephone calls 105 corresponding to selected authentications 125 if those authentications 125 are entered outside selected time periods assigned to those authentications 125. The call routing method may include the step of 657, overriding blocks of the selected authentications 125 by way of breakthrough routing identifiers 140.

The call routing method may include the step of 660, validating selected telephone calls 105 within selected time periods assigned to those selected telephone calls 105. The call routing method may include the step of 662, overriding invalidations of the selected telephone calls 105 by way of breakthrough routing identifiers 140.

The call routing method may include the step of 665, routing the at least one telephone call to a voicemail system 150 operative with branch exchange system 100 and at least one computerized telephone device 130, recording the telephone call as an audio file, converting the audio file into a corresponding text file by way of a speech-to-text software program 170, storing audio file 160 and the text file 165 onto at least one database 155 operative with voicemail system 150, and delivering by way of branch exchange system 100 audio file 160 and text file 165 to at least one computerized telephone device 130 of the at least one computerized telephone device 130.

The call routing method may include the step of 670, routing telephone call 105 to the voicemail system 150 upon branch exchange system 100 receiving an identity code corresponding to that telephone call 105. The call routing method may include the step of 675, delivering by way of the branch exchange system 100 audio file 160 and text file 165 to at least one computerized telephone device 130. The call routing method may include the step of 680, delivering by way of branch exchange system 100 audio file 160 and text file 165 to at least one computerized telephone device 130 by way of manual direction.

The call routing method may include the step of 685, configuring a given computerized telephone device 130 of the at least one computerized telephone device 130 to one of multiple audio file 160 and text file 165 delivery options. The call routing method may include the step of 687, configuring the given computerized telephone device 130 of the at least one computerized telephone device 130 wherein the audio file 160 and text file 165 delivery options include assigning at least one priority-level identifier 180 to selected audio files 160 text files 165. The call routing method may include the step of 690, accepting manual selection of the at least one priority level identifier 180 for telephone call 105. The call routing method may include the step of 695, analyzing by way of a large language module at least one or more of terms, context, inflection, and speech pattern similarity for automated routing prioritization.

A general object of the invention, therefore, is to provide one or more authentication layers where authentication 125 to reach computerized telephone device 130 may be changed while telephone numbers to computerized telephone device 130 are preserved. A secondary object of the invention is to provide breakthrough routing identifiers 140 that give callers possessing one or more breakthrough routing identifiers 140 and, in some instances, one or more second breakthrough numbers 145, agency to override authentication 125 and, if otherwise kept from reaching at least one computerized telephone device 130, nonetheless, reach at least one computerized telephone device 130 or at least alert parties with at least one computerized telephone device 130 that a breakthrough attempt is being made.

Various related embodiments of the inventive concept are also described in the drawings, which are incorporated herein by reference in its entirety. The following patents are incorporated by reference in their entirety: U.S. Pat. Nos. 9,392,120 and 9,319,515.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

### REPRESENTATIVE COMPONENTS

10 Call routing system
100 Branch exchange system
105 Telephone call
110 Session initiation protocol server
115 Firewall
120 Automated attendant system
125 Authentication
130 Computerized telephone device
135 Automatic number identification.
140 Breakthrough routing identifier
145 Second breakthrough routing identifier
150 Voicemail system
155 Database
160 Audio files;
165 Text files
170 Second computerized telephone device
175 Speech-to-text software program
180 Priority-level identifier
400 Toggle switch

1. A call routing system comprising:
a branch exchange system adapted to receive telephone calls;
a session initiation protocol server operative with the branch exchange system, the session initiation protocol server further having a firewall adapted to allow telephone calls to pass therethrough;
at least one automated attendant system adapted to request authentication for said telephone calls;
at least one computerized telephone device adapted to receive telephone calls and notifications of telephone calls routed through the session initiation protocol server and sent from the branch exchange system; and,
the branch exchange system adapted to route telephone calls based on the validity of said authentication.

2. The call routing system of claim 1, wherein telephone calls are further validated by way of automatic number identification.

3. The call routing system of claim 1, wherein telephone calls are adapted to be routed based on validation of at least one breakthrough routing identifier.

4. The call routing system of claim 3 wherein there is at least one second breakthrough routing identifier.

5. The call routing system of claim 1, wherein the branch exchange system is adapted to allow users to add, change, and remove parties from whom telephone calls with valid authentication will be accepted.

6. The call routing system of claim 1, wherein the branch exchange system is adapted to validate selected authentication only if entered within selected time periods assigned to those selected authentications.

7. The call routing system of claim 6, wherein breakthrough routing identifiers are adapted to override invalidations of said selected authentications.

8. The call routing system of claim 1, wherein the branch exchange system is adapted to block selected authentications if entered outside selected time periods assigned to those given authentications.

9. The call routing system of claim 8, wherein breakthrough routing identifiers are adapted to override authentication blocks.

10. The call routing system of claim 1, wherein the branch exchange system is adapted to validate selected telephone calls within selected time periods assigned to those selected telephone calls.

11. The call routing system of claim 10, wherein breakthrough routing identifiers are adapted to override invalidations of said selected telephone calls.

12. The call routing system of claim 1 further comprising:
a voicemail system operative with the branch exchange system and the at least one computerized telephone device, the voicemail system adapted to record said telephone calls as audio files;
a speech-to-text software program adapted to convert said audio files into text files;
at least one database operative with the voicemail system adapted to receive and store audio files and text files of the recorded telephone calls; and,
the branch exchange system adapted to deliver audio files and text files from said at least one database to corresponding computerized telephone devices.

13. The call routing system of claim 12, wherein telephone calls are routed to the voicemail system upon receipt by the branch exchange system of corresponding identity codes.

14. The call routing system of claim 12, wherein the branch exchange system is adapted to deliver audio files and text files to at least one computerized communication device.

15. The call routing system of claim 12, wherein the branch exchange system is adapted to deliver audio files and text files to at least one second computerized telephone device by way of manual direction.

16. The call routing system of claim 12, wherein each computerized telephone device of the at least one computerized telephone device can be configured to one of multiple audio file and text file delivery options.

17. The call routing system of claim 16, wherein each computerized telephone device of the at least one computerized telephone device can be configured wherein audio file and text file delivery options include assigning at least one priority-level identifier for a period of time to the corresponding audio files and text files.

18. The call routing system of claim 17, wherein the at least one priority-level identifier is assigned manually.

19. The call routing system of claim 17, wherein a large language module is adapted to analyze audio files and text files for at least one or more of terms, context, inflection, and speech pattern similarity.

20. A call routing method comprising:
receiving at least one telephone call with a branch exchange system;
initiating a session for the telephone call by way of a session initiation protocol server operative with the branch exchange system, allowing, therefore, the telephone call to pass through a firewall;
requesting authentication for the telephone call by way of at least one automated attendant system;
determining the validity of said authentication;
sending the telephone call, if validated, from the branch exchange to at least one computerized telephone device, the computerized telephone device adapted to receive telephone calls and notifications of telephone calls routed through the session initiation protocol server.

21. The call routing method of claim 20, including validating the telephone call further by way of automatic number identification.

22. The call routing method of claim 20, including validating at least one breakthrough routing identifier wherein the telephone call is adapted to be routable therefrom to at least one computerized telephone device of the at least one computerized telephone device.

23. The call routing method of claim 22, including validating at least one second breakthrough routing identifier.

24. The call routing method of claim 20, including allowing by way of the at least one computerized telephone device adding, changing, and removing parties from which telephone calls with valid authentications will be accepted.

25. The call routing method of claim 20, including validating selected authentications only if entered within selected time periods assigned to those given authentications.

26. The call routing system of claim 25, including overriding invalidations of said selected authentications by way of breakthrough routing identifiers.

27. The call routing system of claim 20, including blocking telephone calls corresponding to selected authentications if those authentications are entered outside selected time periods assigned to those authentications.

28. The call routing system of claim 27, including overriding blocks of said selected authentications by way of breakthrough routing identifiers.

29. The call routing system of claim 20, including validating selected telephone calls within selected time periods assigned to those selected telephone calls.

30. The call routing system of claim 29, including overriding invalidations of said selected telephone calls by way of breakthrough routing identifiers.

31. The call routing method of claim 20 further comprising:
routing the at least one telephone call to a voicemail system operative with the branch exchange system and the at least one computerized telephone device;
recording the telephone call as an audio file;
converting the audio file into a corresponding text file by way of a speech-to-text software program;
storing the audio file and the text file onto at least one database operative with the voicemail system; and
delivering by way of the branch exchange system the audio file and text file to at least one computerized telephone device of the at least one computerized telephone device.

32. The call routing method of claim 31, including routing the telephone call to the voicemail system upon the branch exchange system receiving an identity code corresponding to that telephone call.

33. The call routing method of claim 31, including delivering by way of the branch exchange system the audio file and the text file to at least one computerized communication) device.

34. The call routing method of claim 33, including delivering by way of the branch exchange system the audio file and the text file to at least one computerized communication device by way of manual direction.

35. The call routing method of claim 31, including configuring a given computerized telephone device of the at least one computerized telephone device to one of multiple audio file and text file delivery options.

36. The call routing method of claim 35, including configuring the given computerized telephone device of the at least one computerized telephone device wherein the audio file and text file delivery options include assigning at least one priority-level identifier to selected audio files and text files.

37. The call routing system of claim 36, including accepting manual selection of the at least one priority level identifier for the telephone call.

38. The call routing method of claim 31, including, analyzing by way of a large language module at least one or more of terms, context, inflection, and speech pattern similarity for automated routing prioritization.
